(19) United States
(12) Patent Application Publication
(10) Pub. No.: US 2011/0087608 A1
(43) Pub. Date: Apr. 14, 2011

(54) SYSTEM FOR LOCATING AND LISTING RELEVANT REAL PROPERTIES FOR USERS

(76) Inventors: Tarun Shah, Tustin, CA (US); Kerrigan Burgess, Los Angeles, CA (US)

(21) Appl. No.: 12/876,044

(22) Filed: Sep. 3, 2010

Related U.S. Application Data
(63) Continuation-in-part of application No. 12/141,742, filed on Jun. 18, 2008, now abandoned.

(51) Int. Cl. G06Q 50/00

(52) U.S. Cl. 705/306; 705/313

(57) ABSTRACT

A system and a computer program product for generating a list of real properties from real property listings receives a set of inherent parameters associated with a desired real property from a user. The system retrieves an intermediate list of real properties from the real property listings based on the set of inherent parameters. The system ranks each real property of the intermediate list of real properties based on a set of qualitative parameters associated with the each real property. The qualitative parameters may be provided by a user or may be provided by the system. Thereafter, the system generates a list of real properties from the intermediate list of properties based on the ranking of the each property of the intermediate list of properties. The system may generate the list after normalizing the data used to create the ranks of each property of the intermediate list of properties.

### CROSS REFERENCE TO RELATED APPLICATIONS

The present disclosure is a continuation in part of the U.S. patent application Ser. No. 12/141,742, filed on Jun. 18, 2008, the disclosure of which is incorporated by reference.

### FIELD OF THE DISCLOSURE

The present disclosure generally relates to real properties, and, more particularly, to locating and identifying relevant real properties for users through a communication network.

### BACKGROUND OF THE DISCLOSURE

Shopping for and buying real estate, and the selection of which requires a substantial amount of time and money. Oftentimes, a buyer in the purchase process is shopping for property in an area with which he or she is not familiar, for instance, because he or she has chosen or been forced to relocate to a new city.

Traditionally, and to gain information about a variety of properties that may be suitable to him or her, the prospective buyer will contact a real estate broker (also known as a realtor) to find potential properties of interest. The prospective purchaser may provide parameters or preferences to guide the broker in finding such potential properties. The parameters often include, but of course are not limited to, price, size, and location. The broker may then locate real properties based on the parameters provided by the prospective buyer. However, the real properties located by the broker may not satisfy all the of the buyer's parameters investor. Further, even if the properties returned by the broker fall within the literal bounds of parameters provided by the buyer, the properties may in actuality not meet the buyer's preferences.

With the advent of the internet, databases and advanced communication means, more information on properties is available to prospective buyers. Now buyers have access to similar search facilities that were previously only available to brokers for conveniently searching real property listings. Thus, a buyer unfamiliar with a particular geographical area can perform an online search to locate real properties of interest by him- or herself. These search facilities may include the opportunity $439,748.14 as of Apr. 19, 2010 for the buyer to input particular parameters before properties are located and listed to the buyer.

However, an inherent drawback in these search facilities is the large volume of real property information. The parameters related to the real property may generate a large number of search results, which results may include a variety of properties that are of no interest to the buyer and which results may otherwise be too cumbersome for a buyer to review in full.

Based on the foregoing, there is a need for a system for providing a relevant list of real properties to a prospective buyer or user of the system (as used herein, “user” includes a buyer or prospective buyer of real property). Further, the system should facilitate the user to locate real properties around in near and distant locations in a convenient manner.

### SUMMARY OF THE DISCLOSURE

In view of the foregoing disadvantages inherent in the prior art, the general purpose of the present disclosure is to provision for generating a list of real properties from real property listings, that is configured to include all advantages of the prior art, and to overcome the drawbacks inherent therein.

Therefore, an object of the present disclosure is to generate a list of real properties that is relevant to a user.

Another object of the present disclosure is to generate a list of real properties in a sorted manner.

Yet another object of the present disclosure is to generate a list of real properties for a user that may be emailed or displayed to the user in a convenient manner.

Accordingly, in an aspect of the present disclosure, a system is provided for generating a list of real properties from real property listings. In an embodiment, the system includes receiving a set of inherent parameters associated with a desired real property from a user. Further, the system includes retrieving an intermediate list of real properties from the real property listings based on the set of inherent parameters. Furthermore, the system includes ranking each real property of the intermediate list of real properties based on a at least one qualitative parameter associated with each real property of the intermediate list of real properties. The at least one qualitative parameter may be inputted by a user or may be determined by the system. Still further, the system includes generating the list of real properties from the intermediate list of real properties based on the ranking of each real property of the intermediate list of real properties.

The system of generating the list of real properties also includes arranging the list of real properties in a descending order of weights of the list of real properties. The system of arranging the list of real properties in the descending order generates sorted and relevant real properties for the user.

Further, the system of the present disclosure may be implemented over a communication network, thereby adding convenience to the method.

The system for generating a list of real properties from real property listings for a user may include a transceiver module, a search engine, a ranking module and a generator module. The transceiver module is capable of receiving a set of inherent parameters that are associated with a desired real property. The search engine is capable of retrieving an intermediate list of real properties from the real property listings based on the set of inherent parameters received by the transceiver module. The ranking module is capable of ranking each real property of the intermediate list of real properties based on at least one qualitative parameters associated with each real property of the intermediate list of real properties. The generator module is capable of generating the list of real properties from the intermediate list of real properties based on the ranking of each real property of the intermediate list of real properties by the ranking module.

In yet another aspect of the present disclosure, a computer program product is embodied on a computer readable medium for generating a list of real properties from real property listings. The computer program product includes a program module having a set of instructions for receiving a set of inherent parameters associated with a desired real property from a user. The program module also includes a set of instructions for retrieving an intermediate list of real properties from the real property listings based on the set of inherent parameters received from the user. Further, the program module includes a set of instructions for ranking each real property of the intermediate list of real properties based on at least one qualitative parameter associated with each real property of the intermediate list of real properties. The at least one qualitative parameter may be inputted by a user or may be determined by the system. Furthermore, the program module includes a set of instructions for generating the list of real properties from the intermediate list of real properties based on the ranking of each real property of the intermediate list of real properties.

These together with other aspects of the present disclosure, along with the various features of novelty that characterize the present disclosure, are pointed out with particularity in the claims annexed hereto and form a part of this present disclosure. For a better understanding of the present disclosure, its operating advantages, and the specific objects attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 depicts a schematic diagram of an environment in which various embodiments of the present disclosure may be practiced;

FIGS. 2, 3a and 3b depict functional block diagrams of a system for generating a list of real properties from real property listings, in accordance with various embodiments of the present disclosure;

FIG. 4 is a functional block diagram with preference weights assigned to a set of qualitative parameters, based on a preference of qualitative parameters, in accordance with an exemplary embodiment of the present disclosure;

FIG. 5 depicts an exemplary interface displaying a list of real properties, in accordance with an exemplary embodiment of the present disclosure, and

FIG. 6 is a functional block diagram of a preference engine of a system for generating a list of real properties from real property listings, in accordance with an exemplary embodiment of the present disclosure.

Like reference numerals refer to like parts throughout the description of several views of the drawings.

### DETAILED DESCRIPTION

For a thorough understanding of the present disclosure, reference is to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present disclosure provides a system and a computer program product for generating a list of real properties from real property listings. A set of inherent parameters associated with a desired real property are received from a user. An intermediate list of real properties is retrieved from the real property listings based on the set of inherent parameters received from the user. Each real property of the intermediate list of real properties is ranked based on at least one qualitative parameter associated with the each real property. The at least one qualitative parameter may be inputted by a user or may be determined by the system. The list of real properties is generated from the intermediate list of real properties based on the ranking of the each real property.

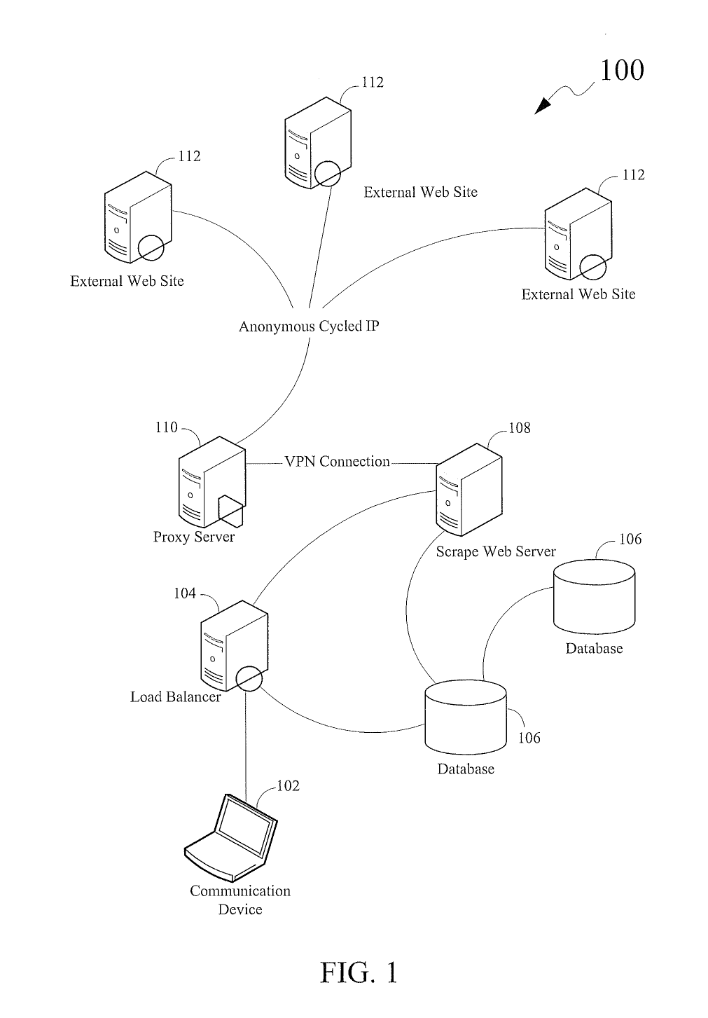

Referring to FIG. 1, a schematic diagram of an exemplary environment 100 is depicted, in which various embodiments of the present disclosure may be practiced. The environment 100 includes a communication device 102, a load balancer 104, a plurality of databases 106, a scrape web server 108, a proxy server 110 and a plurality of external websites 112. It will be apparent to a person skilled in the art that the environment 100 may be a part of a communication network, such as a Local Area Network (LAN), a Wide Area Network (WAN), a Metropolitan Area Network (MAN), and the like. Further, it will be apparent to a person skilled in the art that the communication device 102 is shown for exemplary purposes and more number of communication devices may exist in the environment 100.

Examples of the communication device 102 include, but are not limited to, desktop computers, laptops, mobile phones and Personal Digital Assistants (PDAs). The communication device 102 may be operated by the user, such as an investor, a real property broker, and the like, who is interested in locating a desired real property. The communication device 102 may provide the user an interface that may facilitate the user in locating the desired real property. An example of the interface includes a web browser.

The user may provide a set of inherent parameters associated with the desired real property through the communication device 102. The set of inherent parameters include at least one of list price, square footage, year built, property type, lot size, number of bedrooms, number of bathrooms, location of the real property, population growth within a geographical territory of the real property and job growth in the geographical territory of the real property. It will be apparent to a person skilled in the art that the set of inherent parameters refers to a set of values associated with the set of inherent parameters. The user may provide a specific value for an inherent parameter of the set of inherent parameters. Alternatively, the user may provide a range of values for the inherent parameter. Further, alternatively, the user may select desired values for the set of inherent parameters from the set of values provided in the communication devices. In an embodiment of the present disclosure, the set of values may be provided in drop down select options. The communication device 102 may then transmit the set of inherent parameters to the load balancer 104.

Examples of the load balancer 104 include a server with a dedicated program for load balancing, a hardware device such as a multilayer switch, and the like. The load balancer 104 balances load by spreading work between two or more resources, such as two or more web servers. The load balancer 104 may detect the set of inherent parameters transmitted by a communication device, such as the communication device 102 in the environment 100. Further, the load balancer 104 may forward the set of inherent parameters to an available web server (not shown) of a plurality of web servers (not shown). Each web server of the plurality of web servers deploys a web application. Examples of the web application include, but are not limited to, websites and application programs.

A web application deployed on a web server may receive the set of inherent parameters from the load balancer 104. Further the web application may query a database of the plurality of databases 106 for real property listings based on the set of inherent parameters. Each real property listing of the real property listings may include the set of inherent parameters for a real property, based on the set of inherent parameters provided by the user. More specifically, values of the set of inherent parameters for the each real property listing satisfy the values associated with the set of inherent parameters provided by the user. The database may include the set of inherent parameters for a real property. The database may be a regionalized database that includes information of real properties in a geography specific manner. Further, the database may be a primary database or a replicated database.

The query from the web application may result in the real property listings from the database, such that, the each real property listing satisfies values associated with the set of inherent parameters provided by the user. The web server may then transmit the real property listings to the communication device 102. The communication device 102 may display the real property listings received from the web server to the user through the interface.

Alternatively, the database may contain outdated real property listings. The web server may then communicate with the scrape web server 108 to extract the set of inherent parameters for real properties within a geographical area specified by the user.

The scrape web server 108 may deploy at least one tool for scraping the set of inherent parameters from the plurality of external websites 112. The at least one tool may be based on a data driven approach, such as a data driven approach provided by Extensible Stylesheet Language Transformations (XSLT). The XSLT have an ability to transform Extensible Markup Language (XML) data extracted from a website of the plurality of websites 112 to another type of XML data.

A first tool (hereinafter referred to as ‘link master tool’) of the at least one tool may be involved in identifying an Extensible Stylesheet Language (XSL) required by an external website of the plurality of websites 112 for scraping the set of inherent parameters.

The link master tool may provision targeting a specific external website, such as Yahoo, Remax, Prudential, and the like, and may link a specific XSL to the external website. Further, the link master tool may compile other useful data pertaining to the external website. Examples of the other useful data pertaining to the external website include, number of web requests that may be made simultaneously to the external website, period between consecutive data refreshments on the external website, and the like.

A second tool (hereinafter referred to as ‘flow master tool’) of the at least one tool deployed on the scrape web server 108 may assist the web scrape server 108 to build web requests for the plurality of external websites 112. The flow master tool may build a web request for each external website of the plurality of external websites 112 that needs to be hit in order to scrape the set of inherent parameters. For example, an external website may require a Uniform Resource Locator (URL) to target a geographic area requested by the user, to search the desired real property. The URL may be built by the flow master tool by utilizing the set of inherent parameters received by the load balancer 104. After the URL is built, a web request may be issued by the scrape web server 108 to an external website of the plurality of external websites 112. The external website may send a Hyper Text Markup Language (HTML) response to the scrape web server 108 in response to the web request. Further, the scrape web server 108 may transform the HTML response from the external website into XML. Furthermore, an XSLT may be applied on the XML by the scrape web server 108 to obtain the set of inherent parameters.

It will be apparent to a person skilled in the art that the scrape web server 108 may include a server farm having multiple scrape web servers or a single server as shown in FIG. 1.

The scrape web server 108 may route web requests to the plurality of external websites 112 through the proxy server 110. In an exemplary embodiment, the scrape web server 108 may be coupled to the proxy server 110 through a Virtual Private Network (VPN). The proxy server 110 may handle the web requests sent from the scrape web server 108 to the plurality of external websites 112. Further, the proxy server 110 may also handle HTML responses from the plurality of external websites 112.

It will be apparent to a person skilled in the art that another function of the proxy server 110 may be to anonymize the scraping by the scrape web server 108. The proxy server 110 may cycle anonymous Internet Protocol (IP) addresses to avoid the plurality of external websites 112 from detecting the scraping by the scrape web server 108.

The scrape web server 108 may scrape the plurality of external websites 112 for the set of inherent parameters. The scrape web server 108 may then store the set of inherent parameters in a database of the plurality of databases 106. The database may store the set of inherent parameters of a real property based on the geographical area of the real property, such as east coast, west coast and central. The database may be searched based on the geographical area of the real property that may be specified by the user through the set of inherent parameters.

In an embodiment of the present disclosure, the user may utilize the communication device 102 to provide values associated with the set of inherent parameters of a real property that the user may want to commercialize by leasing, selling or mortgaging. The communication device 102 may include an interface for providing the values associated with the set of inherent parameters. The interface may be a web browser. The communication device 102 may transmit the values associated with the set of inherent parameters to the load balancer 104. The load balancer 104 may forward the values to an available web server (not shown). The web server may then store the values of the real property in a database of the plurality of databases 106.

In another embodiment, the user may have a user account with the web application that may be deployed on a web server. The user account may store the set of inherent parameters of the desired real property that the user is searching. Further, the user account may store the set of inherent parameters of real properties owned by the user, which the user may want to commercialize. User accounts of users of the web application may be maintained in the plurality of databases 106.

It will be apparent to a person skilled in the art that the plurality of databases 106 may follow a protocol for consistency in values of the set of inherent parameters of real properties stored in the plurality of databases 106.

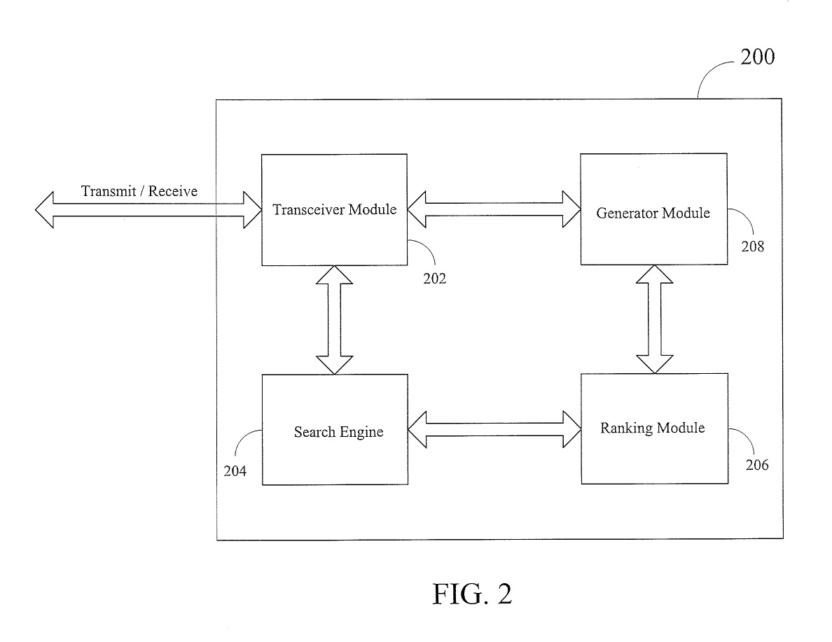

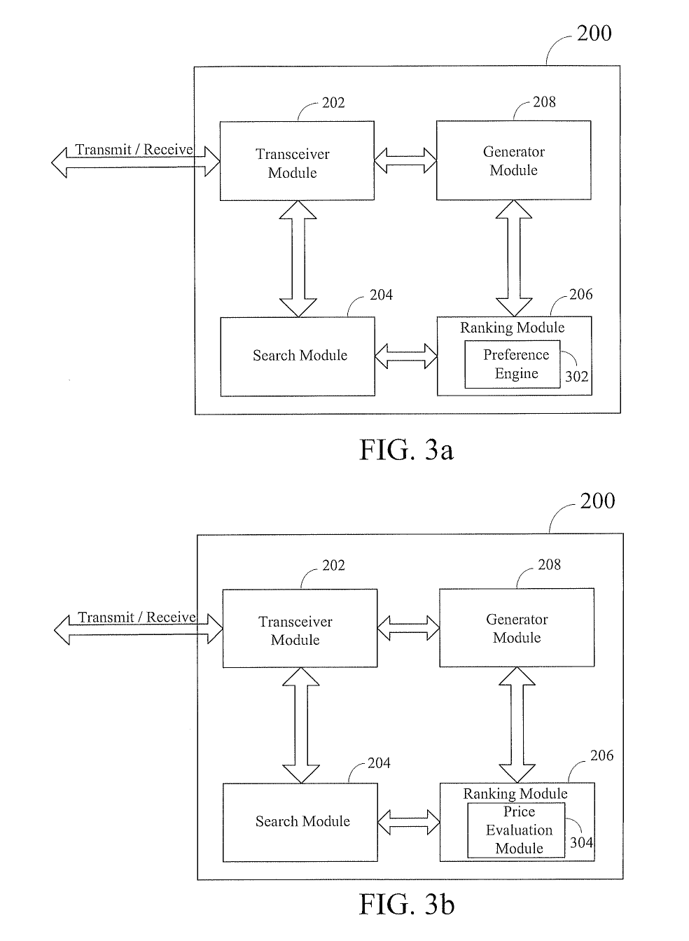

It will also be apparent to a person skilled in the art that the environment 100 as shown in FIG. 1 is for exemplary purposes of the present disclosure and may include more or less number of similar or different components than shown. Further, the web server to which the load balancer 104 forwards the set of inherent parameters received from the user represents a system that generates a list of real properties from the real property listings. FIGS. 2, 3a and 3b depict various embodiments of functional block diagrams of the system for generating a list of real properties from the real property listings.

FIGS. 2, 3a and 3b depict functional block diagrams of a system 200 for generating a list of real properties from real property listings for a user, in accordance with various embodiments of the present disclosure. FIG. 3a depicts a functional block diagram of the system 200 for generating the list of real properties from real property listings for the user based on a preference of at least one qualitative parameter. FIG. 3b depicts a functional block diagram of the system 200 for generating the list of real properties from real property listings for the user based on a comparison of list prices and perceived prices of the list of real properties. For the purpose of description of FIGS. 2, 3a and 3b, reference will be made to the components described in FIG. 1. The system 200 corresponds to an available web server that receives the set of inherent parameters from the load balancer 104, as described in FIG. 1.

As shown in FIG. 2, the system 200 includes a transceiver module 202, a search engine 204, a ranking module 206 and a generator module 208. The transceiver module 202 is capable of receiving the set of inherent parameters associated with the desired property from the user. The search engine 204 is capable of retrieving an intermediate list of real properties from the real property listings based on the set of inherent parameters received by the transceiver module 202. Further, the ranking module 206 is capable of ranking each real property of the intermediate list of real properties retrieved by the search engine 204, based on a set of qualitative parameters associated with the each real property. Furthermore, the generator module 208 is capable of generating the list of real properties from the intermediate list of real properties based on the ranking of the each real property by the ranking module 206.

For the purpose of description of the present disclosure, set of inherent parameters are parameters associated with a real property that are inherent to the real property. Generally, an inherent parameter associated with a real property is a measurable and a quantifiable parameter. Further, a qualitative parameter is a parameter associated with a real property that indicates a quality of the real property. Further, the qualitative parameter associated with the real property is not directly measurable. However, the qualitative parameter may be measurable for a particular geographical area within which the real property lies.

In an embodiment, the transceiver module 202 may be capable of receiving the set of inherent parameters associated with a desired property from a communication device, such as the communication device 102 operated by the user. The user may be an investor, a real property broker, and the like. The set of inherent parameters for a real property may include at least one of list price, square footage, year built, property type, lot size, number of bedrooms, number of bathrooms, location of the real property, population growth within a geographical territory of the real property and job growth in the geographical territory of the real property. However, it will be apparent to a person skilled in the art the set of inherent parameters may include other parameters that may be inherent in nature.

The transceiver module 202 is capable of receiving at least one qualitative parameters from the user through the communication device 102. More specifically, the transceiver module 202 may be capable of receiving a preference of qualitative parameters of the set of qualitative parameters from the user. The preference of qualitative parameters may be representative of qualitative parameters that may be preferred by the user. Alternatively, the preference of qualitative parameters may indicate varying priorities of the set of qualitative parameters for the user. In another embodiment, the system may determine and provide the at least one qualitative parameter, without input from the user. In an embodiment, the qualitative parameter provided by the system may be the best value of a property, which best value may be defined as a ratio of attribute or attributes of a property in question and others in the same location (within a defined proximity, for example), and where such attributes may include, but are not necessarily limited to, the price per square foot, the size of the property's lot, the number of bathrooms, and the year the property was built.

The at least one qualitative parameter of a real property may include at least one of price per square foot, crime rate, standard of schools, median household income, year built, lot size of the real property, history of the real property, type of commercialization, amenities within a geographical territory of the real property, stability in the geographical territory of the real property, expected population growth in the geographical territory of the real property and Gross Domestic Product (GDP) of the geographical territory of the real property. Herein, type of commercialization may include selling, renting, reselling, mortgaging and other types of commercialization. It will be apparent to a person skilled in the art the set of qualitative parameters may include other parameters that may be qualitative in nature or which may be derived from the aforementioned set of qualitative parameters. For example, the user may prefer the qualitative parameters, crime rate and standard of schools, respectively, and in the given order, and may not be concerned with other qualitative parameters.

The search engine 204 may be capable of retrieving an intermediate list of real properties from the real property listings present in a memory module (not shown), based on the set of inherent parameters received by the transceiver module 202. The search engine 204 may also communicate with the transceiver module 202 to obtain the preference of qualitative parameters. Further, the search engine 204 may be capable of retrieving preferred qualitative parameters of the set of qualitative parameters for each real property of the intermediate list of real properties. The preferred qualitative parameters represent the preference of qualitative parameters as preferred by the user. The search engine 204 may retrieve the preferred qualitative parameters for the each real property from the memory module.

The memory module may be configured to store the real property listings. Further, the memory module may be configured to store the set of inherent parameters and the set of qualitative parameters for the each real property. It will be obvious to a person skilled in the art that the memory module may correspond to at least one database of the plurality of databases 106, as explained in FIG. 1. The memory module may facilitate the search engine 204 in retrieving the intermediate list of real properties and the preferred qualitative parameters for the each real property.

The search engine 204 is communicably coupled to the ranking module 206. The ranking module 206 is configured to obtain the intermediate list of real properties from the search engine 204. Further, the ranking module 206 ranks each real property of the intermediate list of real properties based on the at least one qualitative parameter associated with the each real property. More specifically, the ranking module 206 may be capable of ranking the each real property based on the preference of the at least one qualitative parameter provided by the user through the communication device 102 or based on the at least one qualitative parameter provided by the system. In an embodiment, the qualitative parameter provided by the system may be an average of the price per square foot of a property, the lot size of the property, the year the property was built, and the number of rooms of the property. Referring specifically to FIG. 3a, the ranking module 206 includes a preference engine 302. The preference engine 302 is capable of determining a weight of the each real property based on the at least one qualitative parameter retrieved by the search engine 204.

The preference engine 302 may determine the weight of each real property of the intermediate list of real properties retrieved by the search engine 204 by determining a qualitative weight of each qualitative parameter of the preferred qualitative parameters retrieved by the search engine 204 for the each real property and by assigning a preference weight to each qualitative parameter of the preferred qualitative parameters. The preference engine 302 assigns the preference weight to each qualitative parameter of the preferred qualitative parameters based on the preference of qualitative parameters received by the transceiver module 202. The preference weight may be a weight associated with a qualitative parameter of the preferred qualitative parameters that indicates a priority or preference of the qualitative parameter with respect to other qualitative parameters of the preferred qualitative parameters. For example, the user may prefer the crime rate and the standard of schools over other qualitative parameters. The preference engine 302 may assign a preference weight to each of the crime rate and the standard of schools. Further, if the crime rate is a first preference of the user, a higher weight may be assigned by the preference engine 302 to the crime rate as compared to the standard of schools.

Furthermore, the preference engine 302 calculates the weight of the each real property based on the qualitative weight of each qualitative parameter of the preferred qualitative parameters for the real property and the preference weight assigned to each qualitative parameter of the preferred qualitative parameters. In one embodiment, the preference engine 302 is configured to evaluate a product of the qualitative weight of the each qualitative parameter and the preference weight assigned to the each qualitative parameter for the each real property. Further, such products may be evaluated for each qualitative parameter of the preferred qualitative parameters.

In this embodiment, the preference engine 302 is further configured to sum up all such products for the each real property to obtain the weight of the each real property. For example, a real property A may have values of qualitative weights of the preferred qualitative parameters, i.e., the crime rate and the standard of schools as ‘5’ and ‘4’ respectively. Further, preference weights for the crime rate and the standard of schools may be ‘2’ and ‘3’, respectively. Accordingly, the weight of the real property A may then be evaluated by the preference engine 302 to be ‘22’ (obtained by 5*2+4*3). However, it will be apparent to a person skilled in the art that the determination of the weight of the each real property as described above may include any other computation that utilizes the set of qualitative parameters and/or the set of inherent parameters to generate the weight.

To generate more accurate rankings, the qualitative weights and the preference weights for the preferred qualitative parameters may be summed and normalized to determine the weight of the each real property. A real property of the intermediate list of real properties with a lower crime rate, better standard of schools and newer year built may obtain a higher weight as compared to another property with higher crime rate, lower standard of schools and older year built.

The weight determined for each real property of the intermediate list of real properties by the preference engine 302 is utilized by the ranking module 206 to rank the intermediate list of real properties. The ranking module 206 may be communicably coupled to the generator module 208. The generator module 208 communicates with the ranking module 206 to obtain ranking of each real property of the intermediate list of real properties. Further, the generator module 208 is capable of generating the list of real properties from the intermediate list of real properties based on the ranking of each real property of the intermediate list of real properties. In one embodiment, the generator module 208 is capable of arranging the list of real properties in a descending order of the weight determined for the each real property by the preference engine 302 of the ranking module 206. However, it will be apparent to a person ordinary skilled in the art that the generator module 208 may arrange the list of real properties based on other sequences, such as arranging the list of real properties based on a decreasing value of a qualitative parameter of the preferred qualitative parameters.

The transceiver module 202 may be further capable of transmitting the list of real properties to the communication device 102 for displaying the list of real properties to the user. Further, the transceiver module 202 may be capable of transmitting a weight corresponding to each real property of the list of real properties for displaying the list of real properties and their corresponding weights to the user. The weight corresponding to a real property of the list of real properties may indicate suitability of the real property for the user.

The transceiver module 202 may further be capable of transmitting a visual sign corresponding to each real property of the list of real properties, wherein the visual sign may be displayed based on the weight of each real property of the intermediate list of real properties. The visual sign may indicate suitability of each real property of the list of real properties for the user.

The transceiver module 202 may also be configured to email the list of real properties to the user. The transceiver module 202 may be communicably coupled to the search engine 204.

In one specific embodiment of the present disclosure, the system 200 may generate the list of real properties, based on a list price and a perceived price of each real property of the intermediate list of real properties. As mentioned earlier, the list price of a real property is an inherent parameter. For the purpose of description of the present disclosure, the perceived price of a real property may be defined as an evaluated price of the real property that is based on the set of inherent parameters and the set of qualitative parameters of the real property.

Referring specifically to FIG. 3b, the perceived price may be evaluated by an individual, such as a property broker, a government official, and the like. The perceived price of a real property may be stored in the memory module. Alternatively, the perceived price of a real property may be obtained by scraping from the plurality of external websites 112, as explained in FIG. 1. In one embodiment of the present disclosure, the ranking module 206 of the system 200 may include a price evaluation module 304 (as shown in FIG. 3b). The price evaluation module 304 may be configured to compare values associated with the set of qualitative parameters for the each real property with corresponding values of geography-specific set of qualitative parameters. The geography-specific set of qualitative parameters is associated with a geographical territory of the each real property. Examples of the geographical territory may include a county, a state or a zip, where a real property lies. For example, price per square foot of a real property A may be compared with a median price per square foot for the median under which the real property A lies.

The price evaluation module 304 is further configured to evaluate a perceived price for each real property of the intermediate list of real properties, based on the comparison of the set of qualitative parameters with the corresponding geography-specific set of qualitative parameters. Further, the price evaluation module 304 may also be configured to predict perceived prices of the list of real properties. For the purpose of description of the present invention, the perceived price of a real property may be defined as an evaluated price of the real property that is based on the set of inherent parameters and the set of qualitative parameters of the real property.

The price evaluation module 304 of the ranking module 206 is further configured to compute a true price for the each real property of the list of real properties. The true price of a real property corresponds to a price computed by taking into account the perceived price for the real property and an absorption rate of real properties in the geographical territory of the real property. The absorption rate in a geographical territory corresponds to a rate at which a real property within the geographical territory is occupied. Herein the term occupied refers to a real property being sold, rented or filled. The term occupied may also take into account the rate at which a real property is vacated in the geographical territory.

Accordingly, the true price for the each real property is calculated based on the perceived price of the each real property and the absorption rate. Therefore, the true price for the each real property may be greater or less than the perceived price for the each real property depending upon the absorption rate in the geographical territory of the each real property. The true price and the absorption rate corresponding to the each real property of the list of real properties may be transmitted by the transceiver module 202 for displaying the list of real properties, and their corresponding true prices and absorption rates to the user.

The transceiver module 202 may be further capable of transmitting the list of real properties to the communication device 102 for displaying the list of real properties to the user. Further, the transceiver module 202 may be capable of transmitting a weight corresponding to each real property of the list of real properties for displaying the list of real properties and their corresponding weights to the user. The weight corresponding to a real property of the list of real properties may indicate suitability of the real property for the user.

The transceiver module 202 may further be capable of transmitting a visual sign corresponding to each real property of the list of real properties, wherein the visual sign may be displayed based on the weight of each real property of the intermediate list of real properties. The visual sign may indicate suitability of each real property of the list of real properties for the user.

The transceiver module 202 may also be configured to email the list of real properties to the user. The transceiver module 202 may be communicably coupled to the search engine 204.

In one specific embodiment of the present invention, the system 200 may generate the list of real properties, based on a list price and a perceived price of each real property of the intermediate list of real properties. As mentioned earlier, the list price of a real property is an inherent parameter and the perceived price of a real property is an evaluated price of the real property that is based on the set of inherent parameters and the set of qualitative parameters of the real property.

Referring specifically to FIG. 3b, the perceived price may be evaluated by an individual, such as a property dealer, a government official, and the like. The perceived price of a real property may be stored in the memory module. Alternatively, the perceived price of a real property may be obtained by scraping from the plurality of external websites 112, as explained in FIG. 1. In this embodiment of the present invention, the ranking module 206 of the system 200 includes the price evaluation module 304 (as shown in FIG. 3b).

The price evaluation module 304 depicted in FIG. 3b, may have similar functionalities as those described for the preference engine 302 of FIG. 3a above. The price evaluation module 304 of FIG. 3b may be configured to evaluate the perceived price, and the true price of each real property of the list of real properties as described above in conjunction with the price evaluation module 304 of FIG. 3a.

The ranking module 206 may be capable of ranking each real property of the intermediate list of real properties based on a comparison of a list price of the each real property with the perceived price of the each real property. For example, real properties A and B are located in Los Angeles, where the user is interested in a real property deal. Let the list prices of the real properties A and B be $810,000 and $760,000 and corresponding perceived prices be $900,000 and $800,000. The difference in the list price and the perceived price for the real property A is −10 percent, whereas the difference for the real property B is −5 percent. Therefore, the real property A may be considered as a better deal than the real property B. Accordingly, the real property A is provided a higher ranking than the real property B in the list of real properties.

In this embodiment, the transceiver module 202 is capable of transmitting the list of real properties to the communication device 102 for displaying the list of real properties to the user. The transceiver module 202 is further capable of displaying a visual sign corresponding to each real property of the list of real properties based on the comparison of the list price and the perceived price of the each real property by the ranking module 206. The visual sign may include at least one of a percentage, a difference and a ratio corresponding to the list price and the perceived price of the each real property, and a class, a rank and a rating of the each real property.

Further, the transceiver module 202 may be communicably coupled to the search engine 204. The search engine 204 may be configured to retrieve the set of qualitative parameters from the memory module or the plurality of external websites 112, as described previously. Further, the search engine 204 may also be configured to retrieve the geography-specific set of qualitative parameters from the memory module or from the plurality of external websites 112 by scraping.

Further, as explained in FIG. 1, the system 200 may deploy a web application, such as a website, an application program, and the like that may be accessed by the user through the web browser on the communication device 102. The user may have a user account with the web application. The user account may store the set of inherent parameters, the set of qualitative parameters and the preference of qualitative parameters of the desired real property that the user is searching. Further, the user account may store the set of inherent parameters and the set of qualitative parameters of real properties owned by the user, which the user may want to commercialize. User accounts of users of the web application may be maintained in the memory module.

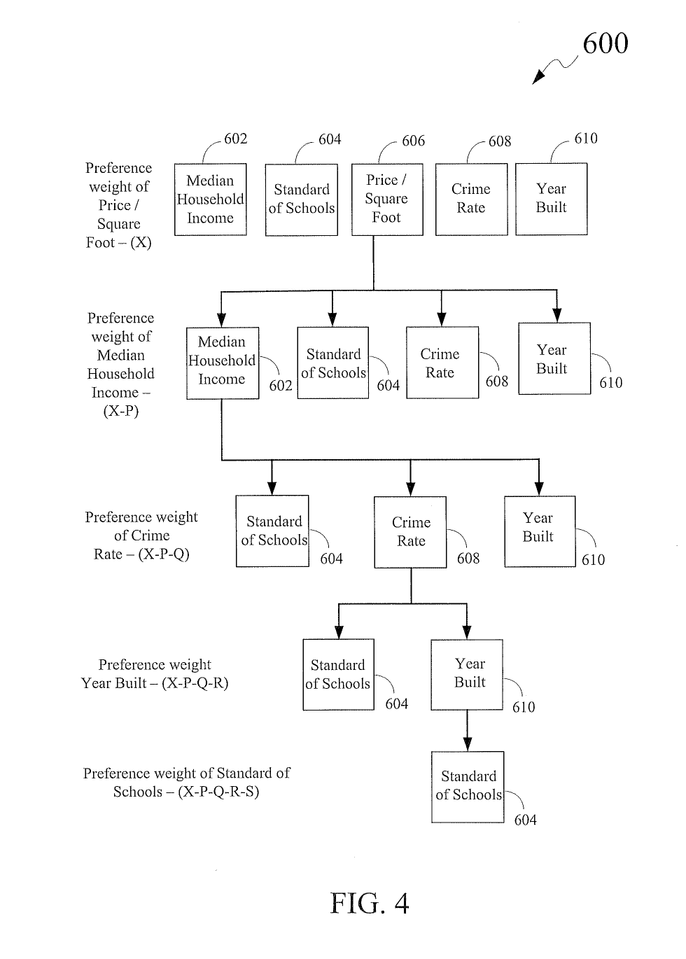

It will be apparent to a person skilled in the art that the components described in FIGS. 2, 3a and 3b, such as the transceiver module 202, the search engine 204, the ranking module 206, the generator module 208, the memory module, the preference engine 302 and the price evaluation module 304 may be implemented as hardware modules, software modules, firmware modules, or any combination thereof. Furthermore, it will be evident to those skilled in the art that the system 200 may include a microprocessor, a battery unit and an input/output (I/O) interface for performing typical functions of a server. The system 200 is used for generating the list of real properties from the real property listings. A method for generating the list of real properties from the real property listings is described in FIG. 4.

In use, a user searching for a desired real property may provide a set of inherent parameters to a system, such as the system 200, through a communication device, such as the communication device 102. The system 200 receives the set of inherent parameters associated with the desired real property from the user. An intermediate list of real properties is retrieved from real property listings based on the set of inherent parameters received from the user. Each real property of the intermediate list of real properties is then ranked based on a set of qualitative parameters associated with the each real property. The list of real properties from the intermediate list of real properties is thereafter generated based on the ranking of each real property of the intermediate list of real properties.

In an embodiment, the user will input the qualitative parameters for use in the ranking of the intermediate list. In another embodiment, the system will provide the qualitative parameter. In the embodiment where the system provides the qualitative parameter, which qualitative parameter is determined, in an embodiment, by an average of the property's price per square foot, lot size, year built, and number of rooms. In yet another embodiment, the qualitative parameter be the best value of a property, which best value may be defined as a ratio of attribute or attributes of a property in question and others in the same location (within a defined proximity, for example), and where such attributes may include, but are not necessarily limited to, the price per square foot, the size of the property's lot, the number of bathrooms, and the year the property was built.

The web browser is an interface that may facilitate the user in locating the desired real property. The user may provide values associated with the set of inherent parameters to specify criteria for the desired real property. For example, the user may require a house in Queens, N.Y. The user may provide values associated with the set of inherent parameters, such as that the house may have three bedrooms, two bathrooms, and a balcony. Further, the user may also provide a list price of the house within the range $300,000 to $500,000.

The user may provide a specific value for an inherent parameter of the set of inherent parameters. Alternatively, the user may enter a range for a value of an inherent parameter of the set of inherent parameters. Further, for the purpose of this description, the values associated with the set of inherent parameters will be referred to as the set of inherent parameters. The set of inherent parameters may include at least one of list price, square footage, year built, property type, lot size, number of bedrooms, number of bathrooms, location of the real property, population growth within a geographical territory of the real property and job growth in the geographical territory of the real property.

Further, each real property of the intermediate list of real properties may be ranked based on the set of qualitative parameters associated with the each real property by a ranking module, such as the ranking module 206. The set of qualitative parameters include at least one of price per square foot, crime rate, standard of schools, median household income, year built, lot size, history of the real property, type of commercialization, amenities within a geographical territory of the real property, stability in the geographical territory of the real property, expected population growth in the geographical territory of the real property and Gross Domestic Product (GDP) of the geographical territory of the real property.

The set of qualitative parameters may be retrieved from the memory module or the plurality of external websites 112 in order to rank the intermediate list of real properties. Alternatively, ranking each real property of the intermediate list of real properties may include determining a perceived price of the each real property based on the set of qualitative parameters and the set of inherent parameters. The set of inherent parameters are provided by the user. The set of qualitative parameters may be evaluated by the ranking module.

As mentioned previously, the perceived price of a real property may be defined as an evaluated price of the real property that is based on the set of inherent parameters and the set of qualitative parameters of the real property. Determining the perceived price of the each real property may include retrieving a geography-specific set of qualitative parameters for the each real property. The geography-specific set of qualitative parameters is associated with a geographical territory of the each real property. Examples of the geographical territory include, but are not limited to, a county, a median, a state, a zip code, a country, a city, and the like. An example of a geography-specific parameter may be, such as, an average value of year built for real properties may be 1990 for a geographical territory, such as Times Square in New York.

Determining the perceived price of the each real property may further include retrieving values of the set of qualitative parameters for the each real property. An example of a value of a qualitative parameter, such as year built, for a real property A, located in Times Square, may be 2000. The values of the set of qualitative parameters for the each real property may be retrieved from the memory module or the plurality of external websites 112. Further, determining the perceived price of the each real property may include comparing a qualitative parameter of the set of qualitative parameters for the each real property with a corresponding geography-specific qualitative parameter of the geography-specific set of qualitative parameters. For example, a qualitative parameter, such as year built, of the real property A may be compared with the average value year built for other real properties in Times Square. A comparison of the value of year built for the real property A with other real properties in Times Square indicates that the real property A is newer than the other real properties in Times Square.

Furthermore, determining the perceived price of the each real property may include evaluating the perceived price of the each real property based on the comparison of the set of qualitative parameters for the each real property with the geography-specific set of qualitative parameters. For example, a comparison may indicate that the real property A is newer than the other real properties in Times Square, thereby increasing a perceived price of the real property A. Similarly, each of the set of qualitative parameters and the corresponding geography specific qualitative parameters of the geography-specific set of qualitative parameters may be compared to evaluate the perceived price of the each real property.

Ranking the each real property may further include comparing a list price of the each real property of the intermediate list of real properties with the perceived price of the each real property. For example, the list price of a real property A located in Westminster in London may be £810,000. Further, the perceived price of the real property A may be £900,000. A difference between the list price and the perceived price of the each real property may be expressed in terms of a percentage. For example, a percentage difference between the list price and the perceived price is −10%.

Furthermore, ranking the each real property may further include ranking the intermediate list of real properties based on the comparison of the list price and the perceived price of each real property of the intermediate list of real properties. For example, consider two real properties, real property A and real property B with their list prices as £810,000 and £750,000, respectively. Further, the perceived prices of the real property A and the real property B are £900,000 and £780,000 respectively. The percentage difference between the list price and the perceived price of the real property A is −10 percent. The percentage difference between the list price and the perceived price of the real property B is −3.8 percent. Accordingly, the real property A is a better deal than the real property B and may be given a higher rank as compared to the real property B.

Based on a rank of each real property of the intermediate list of real properties, the list of real properties may be generated by a generator module, such as the generator module 208. The list of real properties may be a subset of the intermediate list of real properties. The generator module may generate a pre-determined number of real properties in the list of real properties. For example, the list of real properties may include 20 real properties with highest ranks from the intermediate list of real properties.

The list of real properties generated may be displayed to the user through an interface, such as a web browser application installed on a communication device, such as the communication device 102. Further, a visual sign may be displayed corresponding to each real property of the list of real properties based on the comparison of the list price and the perceived price of the each real property. More specifically, the visual sign may include at least one of a percentage, a difference and a ratio corresponding to the list price and the perceived price of the each real property, and a class, a rank and a rating of the each real property. For example, the visual sign for a real property may depict five stars or ‘A’ to indicate a rating or a class of the real property. However, it will be apparent to a person skilled in the art that the comparison of the list price and the perceived price of the each real property may be represented in any other suitable format.

The list of real properties and the visual sign may also be emailed to the user by a transceiver module, such as the transceiver module 202 of the system 200. Further, the set of inherent parameters and the set of qualitative parameters of each real property of the intermediate list of real properties may be stored in the memory module.

In another embodiment, a user searching for a desired real property may provide a set of inherent parameters to a system, such as the system 200, through a communication device, such as the communication device 102. The system may receive the set of inherent parameters associated with the desired real property from the user. Further, the system may check if a set of qualitative parameters have been provided by the user. As explained in FIG. 1, the user may have a user account that may be maintained by the system. The system may check whether the preference of qualitative parameters is provided by the user in the user account maintained by the user. The preference of qualitative parameters may indicate qualitative parameters of the set of qualitative parameters (hereinafter referred to as ‘preferred qualitative parameters’) that may be preferred by the user.

In this embodiment, the set of qualitative parameters may be displayed to the user through the interface presented by the communication device if the preference of qualitative parameters has not been provided by the user. The interface may display the set of qualitative parameters to the user in form of options. For example, the options may be buttons, check boxes, text boxes, drop down select options, and other similar formats capable of accepting multiple options.

In this embodiment, the preference of qualitative parameters of the set of qualitative parameters is received from the user. More specifically, the communication device may enable the user to select one or more qualitative parameters of the set of qualitative parameters that may be displayed. The one or more qualitative parameters selected by the user may be qualitative parameters that are preferred by the user, i.e. the preferred qualitative parameters. The user may also indicate a priority of the preferred qualitative parameters in the preference of qualitative parameters. The priority may be indicated in the preference of qualitative parameters through one of an order of the preferred qualitative parameters, weightiness of the preferred qualitative parameters, rank of the preferred qualitative parameters and class of the preferred qualitative parameters.

More specifically, the user may provide the preference of qualitative parameters in a specific order. The order in which the user provides the preference of qualitative parameters may indicate the priority of qualitative parameters of the preferred qualitative parameters. For example, if a user provides the preferred qualitative parameters in an order as crime rate and standard of schools, the crime rate may have a higher priority as compared to the standard of schools.

Preference weights may be assigned to the preferred qualitative parameters. A preference weight is a weight that may be assigned to a preferred qualitative parameter of the preferred qualitative parameters based on a priority or preference provided by the user to the preferred qualitative parameter. For example, if a user provides two qualitative parameters in an order of crime rate and standard of schools, respectively, the user indicates that crime rate has a higher preference or priority as compared to standard of schools. For example, a preference weight 10 may be assigned to crime rate and a preference weight 7 may be assigned to standard of schools.

The preference of qualitative parameters for the user may be stored in a memory module, such as the memory module, as explained in FIGS. 2, 3a, and 3b. Herein, storing the preference of qualitative parameters may include storing the preference weight for each of the preferred qualitative parameters.

An intermediate list of real properties may be retrieved from the real property listings by a search engine, such as the search engine 204 explained in FIG. 2, based on the set of inherent parameters. The real property listings may be stored in the memory module. Alternatively, the real property listings may be stored on the plurality of external websites 112, as explained in FIG. 1. Each real property of the intermediate list of real properties may include values associated with the set of inherent parameters.

A value of a geography-specific qualitative parameter corresponding to each qualitative parameter of the preferred qualitative parameters may be retrieved by the search engine. The geography-specific qualitative parameter may be restricted to a geographical territory of each real property of the intermediate list of real properties. Examples of the geographical territory include, but are not limited to, a county, a median, a state, a zip code, a country, a city, and the like. For example, if an investor wants to locate a commercial real property in China, he may prefer a qualitative parameter, such as, expected population growth in China. A geography-specific value of the expected population growth in China may be 0.6% and may be retrieved by the search engine. A geography-specific qualitative parameter may be retrieved by scraping the geography-specific qualitative parameter from an information source, such as the plurality of external websites 112 as explained in FIG. 1. It will be evident to a person skilled in the art that the geography specific parameter may be also be retrieved from the memory module.

A weight of each real property of the intermediate list of real properties may be determined based on the preferred qualitative parameters. In one embodiment, the weight of the each real property is calculated based on the qualitative weight of each qualitative parameter of the preferred qualitative parameters for the real property and the preference weight assigned to each qualitative parameter of the preferred qualitative parameters. For example, the qualitative weight of a qualitative parameter of the preferred qualitative parameters, such as crime rate, may be 0.2. The preference weight assigned to the qualitative parameter, such as crime rate, may be 100. Similarly, qualitative weights of other qualitative parameters of the preferred qualitative parameters, such as, standard of schools and year built, may be 0.9 and 5, respectively. The preference weights assigned to standard of schools and year built may be 80 and 60 respectively.

A qualitative weight of each qualitative parameter of the preferred qualitative parameters for the each real property may be determined for the determination of the weight of the each real property. Accordingly, in one embodiment, qualitative weights of the preferred qualitative parameters for the each real property are determined, which includes retrieving values associated with the preferred qualitative parameters for the each real property by the search engine. Alternatively, the values associated with the preferred qualitative parameters for the each real property may be evaluated by an automated real property evaluation tool. Furthermore, each qualitative parameter of the preferred qualitative parameters may be compared with the corresponding geography-specific qualitative parameter retrieved for the each real property.

Specifically, determining the qualitative weights of the preferred qualitative parameters for the each real property may include computing the qualitative weight of the each qualitative parameter, based on the comparison of the each qualitative weight with the corresponding geography-specific qualitative parameter. For example, a real property A located in the Gold Coast of Chicago may be a 2000 square feet property with a list price of $650,000. The real property A may have been built in year 2000 and may have a lot size of 4000 square feet. A price per square foot value for the real property A may be computed to be $325. The price per square foot value for the real property A may be compared with a median value of the price per square foot for the Gold Coast area of Chicago. The median value of the price per square foot for the Gold Coast area of Chicago may be $450 per square foot. Based on a comparison of the price per square foot for the Gold Coast area and the price per square foot for the real property A, a qualitative weight may be assigned to the real property A. It will be apparent to a person skilled in the art that a qualitative weight may be assigned to a qualitative parameter for a real property based on whether an actual value of the qualitative parameter for the real property is greater or less than a value of the corresponding geography-specific qualitative parameter for the real property.

Further, the qualitative weights and the preference weights for the preferred qualitative parameters may be summed and normalized to determine the weight of the each real property. A real property of the intermediate list of real properties with a lower crime rate, better standard of schools and newer year built may obtain a higher weight as compared to another property with higher crime rate, lower standard of schools and older year built. By determining the weight of each real property through summing and normalization of the qualitative weights and preference weights of the preferred qualitative parameters, the system disclosed herein generates listings that are substantially free from outliers and are otherwise more reliable as being more reflective of the user's preferences. Further, the list of properties so generated assures that a higher scoring property will always be ranked above a lower scoring property.

The intermediate list of real properties may be ranked based on the weight determined for the each real property. As explained previously, the weight of the each real property is computed based on the preference of qualitative parameters and the set of inherent parameters. A real property of the intermediate list of real properties with a higher weight will be ranked higher. For example, consider a real property A and a real property B with corresponding weights 20 and 15, respectively. The real property A may be more suitable for the user due to higher weight of the real property A. Hence, the real property A will be ranked higher than the real property B, which signifies than the real property A is a better deal than the real property B.

The list of real properties may be generated from the intermediate list of real properties based on the ranking of the intermediate list of real properties. In an embodiment, generating the list of real properties includes arranging the list of real properties in a descending order of the weight of each real property of the list of real properties. For example, 20 real properties with highest ranks may be utilized to generate the list of real properties. The 20 real properties may be arranged in a descending order of the weight or the rank of each real property of the list of real properties.

Alternatively, generating the list of real properties may include arranging the list of real properties based on at least one qualitative parameter of the set of qualitative parameters. The at least qualitative parameter may be one of the preferred qualitative parameters or any other qualitative parameter.

The list of real properties may be transmitted for display to the user on the communication device. The list of real properties may be displayed to the user by the communication device through an interface, such as a web browser. The list of real properties may be displayed to the user along with the weight corresponding to each real property of the list of real properties. Alternatively, a visual sign may be displayed corresponding to the each real property. The visual sign may be displayed based on the weight of the each real property of the list of real properties. The visual sign may represent one of a rank, a rating, a class, a ratio and a value. The list so generated displays the properties as continuous, as opposed to grouped, items, such that any ambiguity as to a particular property's relative ranking as against other properties in the list does not arise.

Further, the list of real properties may also be emailed to the user on an email account provided by the user. Similar to displaying the list of real properties, the visual sign or the weight corresponding to the each real property may also be emailed to the user.

FIG. 4 depicts a functional block diagram 600 with preference weights assigned to a set of qualitative parameters, based on a preference of qualitative parameters, in accordance with an exemplary embodiment of the present disclosure. For the purpose of description of FIG. 4, reference will be made to FIGS. 1, 2, 3a, and 3b described above. As explained previously, a preference weight is a weight that may be assigned to a preferred qualitative parameter of the preferred qualitative parameters based on a priority or preference provided by a user to the preferred qualitative parameter.

The functional block diagram 600 includes a qualitative parameter 602, a qualitative parameter 604, a qualitative parameter 606, a qualitative parameter 608 and a qualitative parameter 610. For exemplary purposes, the qualitative parameter 602 represents media household income, the qualitative parameter 604 represents standard of schools, the qualitative parameter 606 represents price per square foot, the qualitative parameter 608 represents crime rate and the qualitative parameter 610 represents year built. However, it will be apparent to a person skilled in the art that functional block diagram 600 may include other qualitative parameters, such as, lot size, history of the real property, type of commercialization, amenities within a geographical territory of the real property, stability in the geographical territory of the real property, expected population growth in the geographical territory of the real property and Gross Domestic Product (GDP) of the geographical territory of the real property.

As explained previously, a user may indicate the preference of qualitative parameters through an interface, such as a web browser, provided by a communication device, such as the communication device 102. The preference of qualitative parameters indicates preferred qualitative parameters of the set of qualitative parameters, as explained previously. The functional block diagram 600 depicts that a priority of the preferred qualitative parameters is in order of the qualitative parameter 606, i.e. price per square foot, the qualitative parameter 602, i.e. median household income, the qualitative parameter 608, i.e. crime rate, the qualitative parameter 610, i.e. year built and the qualitative parameter 604, i.e. standard of schools.

The qualitative parameter 606, i.e. price per square foot has highest priority and hence is assigned a preference weight of X. Similarly, the qualitative parameter 602, the qualitative parameter 608, the qualitative parameter 610 and the qualitative parameter 604 have been assigned preference weights of (X-P), (X-P-Q), (X-P-Q-R) and (X-P-Q-R-S), respectively. X, P, Q, R and S are variables (hereinafter referred to as ‘variables X, P, Q, R and S’) that may be assigned any numeric values. For example, the variables X, P, Q, R and S may be assigned values 20, 1, 2, 3 and 4 respectively. Therefore, the preference weights assigned to the qualitative parameters 606, 602, 608, 610 and 604 are 20, 19, 17, 14 and 10 respectively.

It will be evident to a person skilled in the art that any numeric values may be assigned to the variables X, P, Q, R and S based on the preference of qualitative parameters provided by the user.

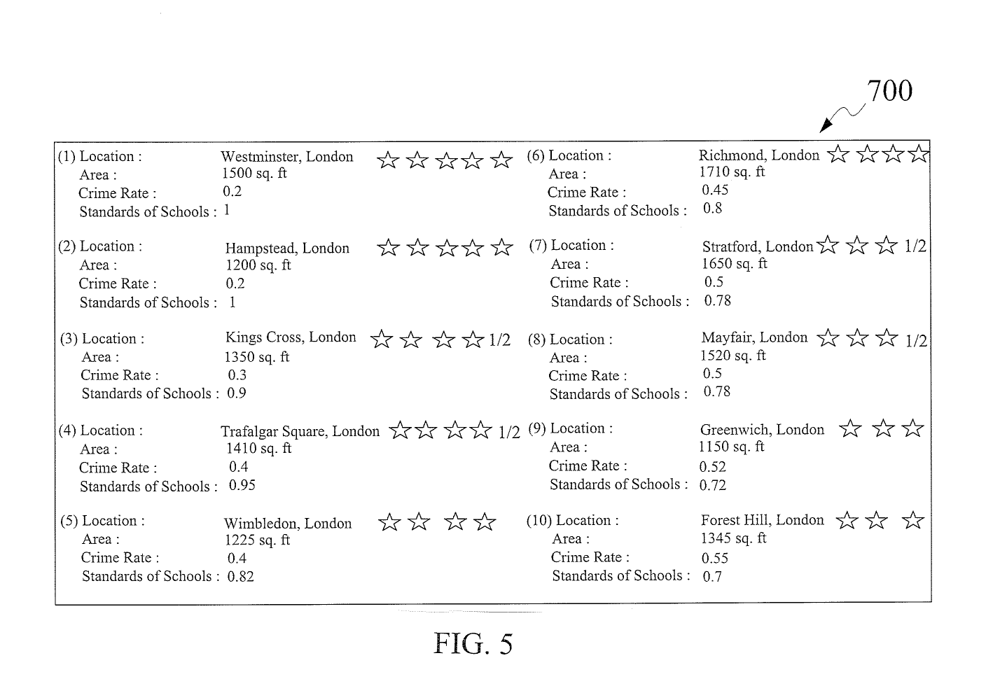

FIG. 5 depicts an interface 700 displaying a list of real properties arranged in a descending order based on weights assigned to a set of qualitative parameters, in accordance with an exemplary embodiment of the present disclosure. For the purpose of description of FIG. 5, reference will be made to FIGS. 1-4 described above. The interface 700 may be displayed to the user on a communication device, such as the communication device 102 explained in FIG. 1.

As depicted in the interface 700, ten real properties are displayed in a descending order of priority. The properties are displayed in continuous fashion, as opposed to grouped fashion, such that any ambiguity as to a particular property's relative ranking as against other properties in the list does not arise. It will be apparent to a person skilled in the art that the interface 700 represents an exemplary interface. In the interface 700, the preference of qualitative parameters is crime rate followed by standard of schools. Each real property of the list of real properties has a corresponding visual sign displayed horizontally across the each real property. As explained previously, the visual sign before a real property represents a rating of the real property, which also corresponds to the weight of the real property. It will be evident to a person skilled in the art that the visual sign may be represented in any other way, as explained previously.

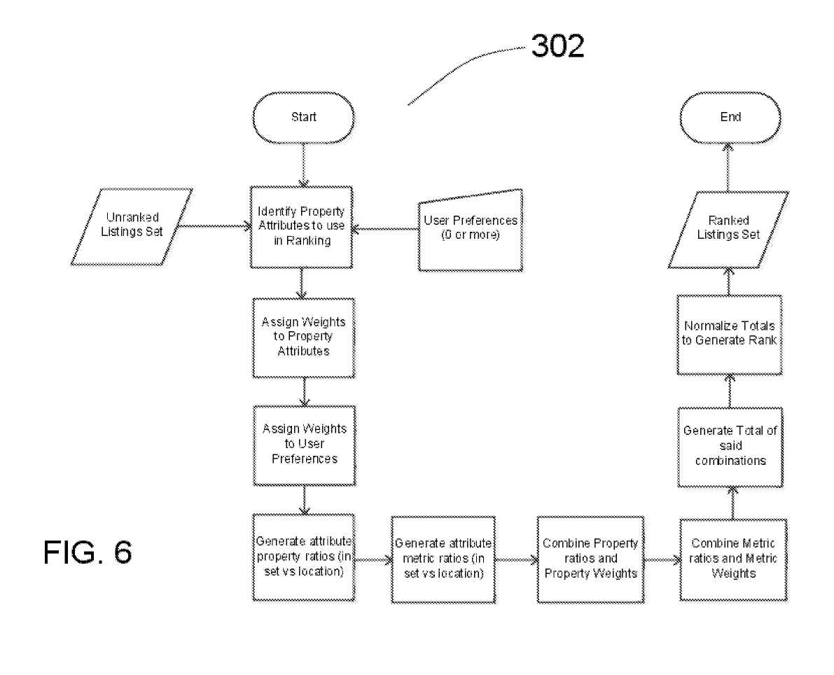

Referring now to FIG. 6, a functional block diagram of another embodiment of a system for locating and listing relevant realty properties is shown. The system identifies property attributes for use in the ranking. The attributes may be generated by a user or by the system. In the event that the system generates the attributes, the attributes may be drawn from an unranked set of listed properties. The system assign weights to the property attributes. The system also assigns weights to user preferences, and it will be understood that the system may assign weights based on weights provided by the user or based on reference to a database or other third party data.

The system generates attribute ratios between properties in the set of properties and properties in the same geographic location of the set of properties that are not members of the set. The system may also generate metric ratios between properties of the set and properties of the same location that are not members of the set. Such metrics may include, but are not limited to, the number of schools, the rating of schools, crime rates, and median income. The system combines the ratios and property attribute weights and, in an embodiment, combines the metric ratios and ratio weights, and generates totals of said combinations. The system performs further analysis of said totals by way of normalization or regression for example, to eliminate outliers and to otherwise revise the results of the ranking and then displays the ranking of properties to the user, which display may be in the form of the display as discussed above.

Generating a list of real properties as implemented by a system, such as the system 200 of the present disclosure, is advantageous for locating a list of real properties that are relevant to a user. The system enables generation of the list of real properties in a sorted manner and convenient manner. Further, the system enables a user who may be unaware of a geographical territory to locate a suitable real property in the geographical territory considering the qualitative parameters for the real property to the user. The system may offer features, such as the “best deal” that may benefit the user in locating real properties that provide value for money. Further, the arrangement of the list of real properties in a descending order based on a preference of qualitative parameters reduces burden on the user for sorting out real properties obtained from a large database.

As described above, the embodiments of the present disclosure may be embodied in the form of a computer program product for generating a list of real properties for a user. Embodiments of the present disclosure may also be embodied in the form of program module containing a set of instructions embodied in tangible media, such as floppy diskettes, CD-ROMs, hard drives, or any other computer-readable storage medium, wherein, when the program module is loaded into and executed by a computer, the computer becomes an apparatus for practicing the present disclosure. It will be apparent to a person skilled in the art that the present disclosure as described above, may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present disclosure. When implemented on a general-purpose microprocessor, the computer program code segments configure the microprocessor to create specific logic circuits.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

1. A system for generating a list of real properties from real property listings for a user, the system comprising:
a transceiver module capable of receiving a set of inherent parameters associated with a desired real property from the user;
a search engine capable of retrieving an intermediate list of real properties from the real property listings based on the set of inherent parameters received by the transceiver module;
a ranking module capable of ranking each real property of the intermediate list of real properties based on at least one qualitative parameter associated with the each real property; and
a generator module capable of generating the list of real properties from the intermediate list of real properties based on the ranking of the each real property by the ranking module.

2. The system of claim 1, wherein the transceiver module is further capable of receiving a preference of qualitative parameters of the qualitative parameters.

3. The system of claim 1, wherein the search engine is further capable of retrieving preferred qualitative parameters of the qualitative parameters for each real property of the intermediate list of real properties, the preferred qualitative parameters representative of the preference of qualitative parameters of the set of qualitative parameters.

4. The system of claim 1, wherein the ranking module comprises a preference engine capable of determining a weight of each real property of the intermediate list of real properties based on the preferred qualitative parameters retrieved by the search engine.

5. The system of claim 4, wherein the preference engine determines the weight of each real property of the intermediate list of real properties retrieved by the search engine by:
determining a qualitative weight of each qualitative parameter of the preferred qualitative parameters retrieved by the search engine for the each real property;
assigning a preference weight to the each qualitative parameter of the preferred qualitative parameters based on the preference of qualitative parameters received by the transceiver module; and
calculating the weight of the each real property based on the qualitative weight of the each qualitative parameter of the preferred qualitative parameters for the real property and the preference weight assigned to the each qualitative parameter of the preferred qualitative parameters.

6. The system of claim 4, wherein the ranking module is further capable of ranking the intermediate list of real properties based on the weight determined for each real property of the intermediate list of real properties by the preference engine.

7. The system of claim 4, wherein the ranking module further comprises a price evaluation module configured to
compare the set of qualitative parameters for each real property of the intermediate list of real properties with corresponding geography-specific set of qualitative parameters, the geography-specific set of qualitative parameters associated with a geographical territory of the each real property; and
evaluate a perceived price for the each real property based on the comparison of the set of qualitative parameters with the corresponding geography-specific set of qualitative parameters.

8. The system of claim 7, wherein the price evaluation module is further configured to
determine an absorption rate of real properties in a geographical territory of each real property of the list of real properties;
determine a market type of real properties in the geographical territory of each real property based on the absorption rate; and
determine a true price for the each real property based on the perceived price of the each real property, absorption rate in the geographical territory of the each real property and the market type in the geographical territory of the each real property.

9. The system of claim 1, wherein the generator module is further capable of: arranging the list of real properties in a descending order of the weight determined for the each real property by the preference engine; and arranging the list of real properties based on at least one of the preferred qualitative parameters retrieved by the search engine.

10. The system of claim 1, wherein the ranking module comprises a price evaluation module configured to compare the set of qualitative parameters for the each real property of the intermediate list of real properties with corresponding geography-specific set of qualitative parameters, the geography-specific set of qualitative parameters associated with a geographical territory of the each real property; and evaluate a perceived price for the each real property based on the comparison of the set of qualitative parameters with the corresponding geography-specific set of qualitative parameters.

11. The system of claim 1, wherein the ranking module is further capable of ranking each real property of the intermediate list of real properties based on a comparison of a list price of each real property of the intermediate list of real properties with the perceived price of the each real property.

12. A computer program product embodied on a computer readable medium, for generating a list of real properties from real property listings, the computer program product comprising a program module executable on a computer, and when executed, the program module comprising:
a set of instructions for receiving a set of inherent parameters associated with a desired real property from a user;
a set of instructions for retrieving an intermediate list of real properties from the real property listings based on the set of inherent parameters received from the user;
a set of instructions for ranking each real property of the intermediate list of real properties based on at least one qualitative parameter associated with the each real property;
and a set of instructions for generating the list of real properties from the intermediate list of real properties based on the ranking of the each real property.

13. The computer program product of claim 12, wherein the set of instructions for ranking each real property of the intermediate list of real properties comprises:
a set of instructions for receiving a preference of qualitative parameters of the qualitative parameters from the user;
a set of instructions for retrieving preferred qualitative parameters of the set of qualitative parameters for each real property of the intermediate list of real properties, the preferred qualitative parameters representative of the preference of qualitative parameters;
a set of instructions for determining a weight of each real property of the intermediate list of real properties based on the preferred qualitative parameters; and
a set of instructions for ranking the intermediate list of real properties based on the weight determined for each real property of the intermediate list of real properties.

14. The computer program product of claim 12, wherein the program module further comprises a set of instructions for determining a true price corresponding to each real property of the list of real properties, the set of instructions comprising.
a set of instructions for determining a perceived price of each real property of the list of real properties, wherein said instructions for determining a perceived price of real property comprise
a set of instructions for retrieving a geography-specific set of qualitative parameters for the each real property, the geography-specific set of qualitative parameters associated with the geographical territory of the each real property;
a set of instructions for retrieving the set of qualitative parameters for the each real property;
a set of instructions for comparing a qualitative parameter of the set of qualitative parameters for the each real property with a corresponding geography-specific qualitative parameter of the geography-specific set of qualitative parameters; and a set of instructions for evaluating the perceived price of the each real property based on the comparison of the set of qualitative parameters for the each real property with the geography-specific set of qualitative parameters.
a set of instructions for determining an absorption rate of real properties in a geographical territory of the each real property;
a set of instructions for determining a market type of the geographical territory of the each real property based on the absorption rate; and
a set of instructions for computing the true price for the each real property based on the absorption rate in the geographical territory of the each real property, the market type of the geographical territory of the each real property and the perceived price of the each real property.

15. The computer program product of claim 12, wherein the set of instructions for determining the weight of each real property of the intermediate list of real properties comprises:
a set of instructions for determining a qualitative weight of each qualitative parameter of the preferred qualitative parameters for the each real property;
a set of instructions for assigning a preference weight to the each qualitative parameter of the preferred qualitative parameters based on the preference of qualitative parameters; and
a set of instructions for calculating the weight of the each real property based on the qualitative weight of the each qualitative parameter of the preferred qualitative parameters for the real property and the preference weight assigned to the each qualitative parameter of the preferred qualitative parameters.

16. The computer program product of claim 15, wherein the set of instructions for determining the qualitative weight of the each qualitative parameter for the each real property comprises:
a set of instructions for retrieving a geography-specific qualitative parameter corresponding to the each qualitative parameter, the geography-specific qualitative parameter restricted to a geographical territory of the each real property;
a set of instructions for comparing the each qualitative parameter with the corresponding geography-specific qualitative parameter retrieved; and
a set of instructions for computing the qualitative weight of the each qualitative parameter based on the comparison of the each qualitative weight with the corresponding geography-specific qualitative parameter.

17. The computer program product of claim 12, wherein the set of instructions for ranking each real property of the intermediate list of real properties comprises:
a set of instructions for determining a perceived price of the each real property based on the set of qualitative parameters and the set of inherent parameters, the set of instructions comprising
a set of instructions for retrieving a geography-specific set of qualitative parameters for the each real property, the geography-specific set of qualitative parameters associated with a geographical territory of the each real property;
a set of instructions for retrieving the set of qualitative parameters for the each real property;
a set of instructions for comparing a qualitative parameter of the set of qualitative parameters for the each real property with a corresponding geography-specific qualitative parameter of the geography-specific set of qualitative parameters; and
a set of instructions for evaluating the perceived price of the each real property based on the comparison of the set of qualitative parameters for the each real property with the geography-specific set of qualitative parameters
a set of instructions for comparing a list price of the each real property of the intermediate list of real properties with the perceived price of the each real property; and
a set of instructions for ranking the intermediate list of real properties based on the comparison of the list price and the perceived price of the each real property of the intermediate list of real properties.

18. The computer program product of claim 17, wherein the program module further comprises a set of instructions for determining the true price for the each real property, the set of instructions comprising:
a set of instructions for determining an absorption rate of real properties in a geographical territory of the each real property;
a set of instructions for determining a market type of the geographical territory of the each real property based on the absorption rate; and
a set of instructions for computing the true price for the each real property based on the absorption rate in the geographical territory of the each real property, the market type of the geographical territory of the each real property and the perceived price of the each real property.

19. A system for generating a ranked list of real properties from real property listings for a user, the system comprising
identifying relevant property attributes to use in ranking;
assigning weights to each of the said attributes,
generating attribute ratios between properties in a set and others in the same location,
ordering said ratios and assigning attribute weights to generate total, and
normalizing said totals to generate a rank.

20. The system of claim 19, wherein the system further comprises
identifying at least one user preference after identifying at least one relevant property attribute to use in ranking,
assigning weights to each of at least one user preference after assigning weights to each at least one property attribute,
generating attribute rations between properties,
assigning weights to each of the at least one property attributes,
assigning weights to each of the at least one user preference
generating attribute ratios between properties that include relevant attributes and properties in the same location that do not include the relevant attributes,
generating attribute ratios between metrics in a location and metrics across locations,
combining attribute ratios of properties and assigned weights combining attribute of metrics and assigned weights,
generating a plurality of totals from said combinations, and
normalizing said totals to generate a list of ranked properties.
